(19) United States
(12) Patent Application Publication
(10) Pub. No.: US 2018/0221839 A1
(43) Pub. Date: Aug. 9, 2018

(54) Chemical Solution Proportioning Method

(71) Applicant: Timothy Sherwood Aselton, II, Tallahassee, FL (US)

(72) Inventor: Timothy Sherwood Aselton, II, Tallahassee, FL (US)

(21) Appl. No.: 15/185,012

(22) Filed: Jun. 16, 2016

Related U.S. Application Data
(60) Provisional application No. 62/180,178, filed on Jun. 16, 2015.

(51) Int. Cl. B01F 15/02; B01F 13/10; B08B 3/02; B08B 3/08; B08B 3/10

(52) U.S. Cl. CPC B01F 15/0216; B01F 13/1055; B01F 15/0261; B08B 2203/0223; B08B 3/08; B08B 3/10; B01F 2215/004; B08B 3/02

(57) ABSTRACT

The steps of providing a cleaning device, a liquid proportioning device and a series of tanks filled with liquids. The cleaning device has a nozzle, a series of hoses and a pump. The liquid proportioning device includes a series of passageways, having three chambers and two valves, and a manifold for mixing the liquids to form a cleaning solution. The passageways include knobs to set the ratio of each liquid that the user desires to mix into a cleaning solution. Once the cleaning solution is mixed, it is fed through a pump to cleaning device for use. The proportioning device allows a user to easily, quickly and accurately mix liquids to form a cleaning solution.

### CROSS-REFERENCES TO RELATED APPLICATIONS

Pursuant to the provisions of 37 C.F.R. § 1.53(c), this non-provisional application claims the benefit of an earlier-filed provisional patent application. The earlier application was assigned Ser. No. 62/180,178. It lists the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

This invention relates to a system and method of combining solutions of liquid. More specifically, the invention comprises a method of proportioning and combining chemical solutions for use in hydro-cleaning.

### 2. Description of the Related Art

Hydro-cleaning describes the use of water propelled at relatively high speeds in order to clean surfaces and materials. Pressure washing or power washing refers to the process of using a high-pressure sprayer to remove dirt, mud, grime, mold or loose paint from the surface of buildings, decks, concrete or other surfaces or objects. A pressure washer device sprays a mixture of liquid at a high velocity onto the desired surface. Typically, a large volume of mixture or solution is needed to adequately wash an area.

Water alone is used for many cleaning applications, typically in high pressure power washing or pressure washing. However, water in combination with special chemicals is desirable to aid in cleaning certain surfaces or objects. This is often the case for professional hydro-cleaning services. The use of chemicals mixed with water is especially applicable in the case of “soft washing.” Soft washing combines certain chemicals with water in order to clean surfaces or materials which cannot be exposed to such high pressures as those used with power washing such as house siding, roofing, etc. Soft washing is performed at much lower pressures than power washing and pressure washing, thereby typically requiring a chemical mixture to perform the cleaning. A chemical mixture or solution must be pre-mixed before it is used to hydro-clean a surface. Therefore, a professional hydro-cleaner typically arrives at a site, spends time mixing the solution and then washes the area or surface to be cleaned. An accurate proportion of chemicals is important, therefore if the user fails to add the correct proportion or runs out of a chemical on-site, the user stands to lose valuable time and resources. Additionally, it is often difficult for a user to mix the solution accurately. An inaccurate mixture may result in less than desirable soft washing results. Further, the user may mix too much solution, which may require the user to discard the solution upon finishing the washing.

It would be beneficial to have a method to prepare solutions on-site, proportioning the chemicals accurately and mixing the solution concurrently with the hydro-cleaning itself. The method should allow multiple liquids to be mixed accurately at any given ratio using suction,

Therefore what is needed is a method which allows a user to attach a proportioning device to a series of tanks containing liquids, mix a solution of pre-set ratios of liquids and use the solution to hydro-clean a surface or object. The present invention achieves this objective, as well as others that are explained in the following description,

### BRIEF SUMMARY OF THE INVENTION

The present method comprises the steps of providing a cleaning device, a liquid proportioning device and a series of tanks filled with liquids. The cleaning device has a nozzle, a series of hoses and a pump. The liquid proportioning device includes a series of passageways, having three chambers and two valves, and a manifold for mixing the liquids to form a cleaning solution. The passageways include knobs to set the ratio of each liquid that the user desires to mix into a cleaning solution. Once the cleaning solution is mixed, it is fed through a pump to the cleaning device for use. The proportioning device allows a user to easily, quickly and accurately mix liquids to form a cleaning solution. The method reduces wasteful by-product and saves time.

### BRIEF DESCRIPTION OF THE SEVERAL VIEWS OF THE DRAWINGS

FIG. 1 is a perspective view, showing a prior art pressure washing system.

FIG. 2 is a perspective view, showing the present proportioning system.

FIG. 3 is a schematic view, showing the proportioning device.

FIG. 4 is a perspective view, showing an alternate embodiment of the proportioning device.

FIG. 5 is a cross section view, showing a multi-chambered passageway of the present proportioning device.

FIG. 6 is a cut-away view, showing a multi-chambered passageway of the present proportioning device.

FIG. 7 is a perspective view, showing one embodiment of the present proportioning system as installed on a vehicle.

FIG. 8 is a cut-away view, showing an alternate valve used in the present proportioning device.

FIG. 9 is a cut-away view, showing another alternative for a valve used in the present proportioning device.

FIG. 10 is a cut-away view, showing another alternative for a valve used in the present proportioning device.

FIG. 11 is a cut-away view, showing different placement of valves.

### REFERENCE NUMERALS IN THE DRAWINGS

10 hydro-cleaner
12 pump
14 high pressure liquid line
16 liquid jet
18 handle
20 nozzle
22 proportioning device
24 hose
26 prior art tank
28 manifold
30 cap
32 first chamber
34 second chamber
36 knob
38 plunger
40 second valve
42 first valve
44 third chamber
46 stem
48 sphere
50 passage-way
52 tank
54 beveled opening
56 truck
58 access point
60 valve opening
64 component

### DETAILED DESCRIPTION OF THE INVENTION

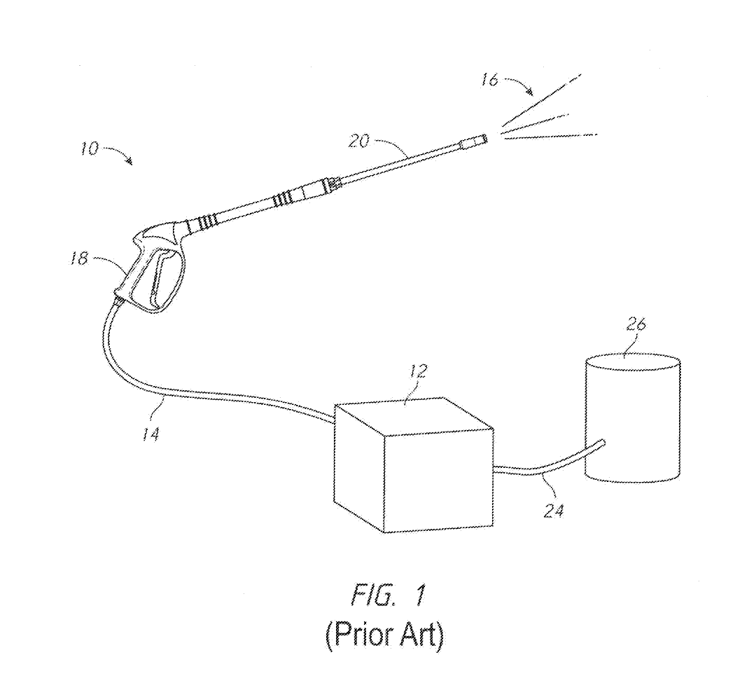

FIG. 1 illustrates a prior art hydro-cleaning system. Hydro-cleaner 10 is known and generally consists of a pump 12, high pressure liquid line 14, handle 18 and nozzle 20. The pump 12 pressurizes a liquid which is fed into the pump 12 by a hose 24. The hose 24 can be connected to a tank 26 or directly to a water spigot. The liquid travels through a high pressure liquid line 14 to the handle 18 and ultimately out of nozzle 20, providing a liquid jet 16 which can be used to clean a surface or object. If the user requires a mixture of liquids, a tank 26 is used to mix the liquids together in the desired proportions. The tank 26 can then be hooked up to a hose 24 which feeds into the pump 12. If a mixture of liquids is desired, the correct ratios of the liquids must be mixed, often on-site prior to using the hydro-cleaner 10, “Soft washing” is a type of hydro-cleaning which is performed at much lower pressures than power washing and pressure washing. A hydro-cleaner 10 can be used and set to a low pressure, or a similar prior art device can be used, which just includes a tank 26, pump 12 and a nozzle 20, such as a typical garden hose nozzle.

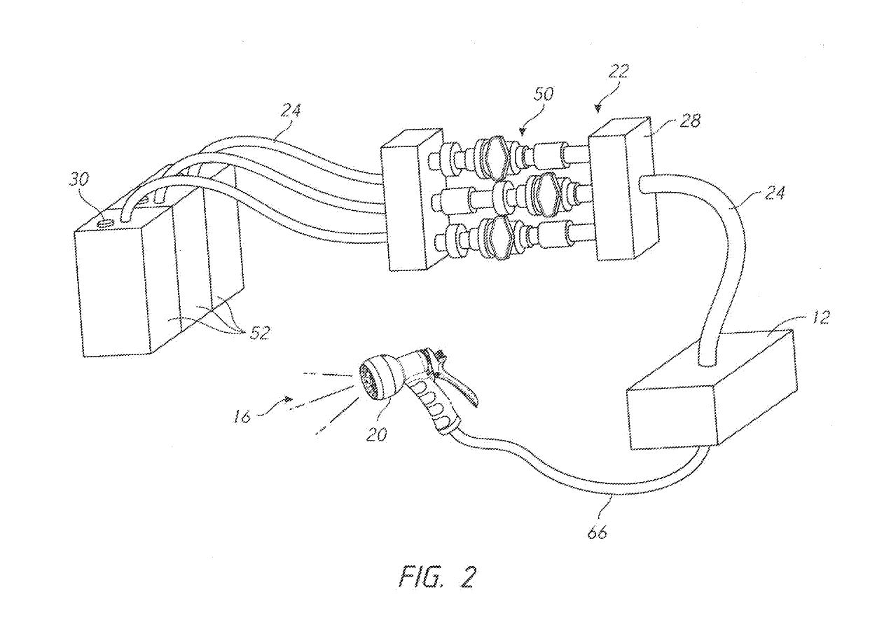

The present proportioning system provides an efficient, accurate method of mixing a solution and using that solution to soft wash a surface or object. FIG. 2 illustrates the general component parts of the proportioning system. The system is generally comprised of a series of tanks 52 (also referenced as first, second and third tank), a proportioning device 22, a pump 12 and a nozzle 20. As illustrated, series of tanks 52 are connected via a set of first hoses 24 (first, second and third hoses) to proportioning device 22. Hose 24 preferable is top fed through the top of tanks 52 and extend downward to the base of the tanks. This prevents the pressure of the liquid in the tanks 52 from affecting the flow of the liquids through proportioning device. Series of tanks 52 are capable of being filled with a variety of different liquids. A cap 30 can optionally be provided at the top of each tank 26 to fill tank 26 with the desired liquid. Desirable liquids may include water, bleach, soap, etc. In order to provide the correct ratio of liquids into the mixture proportioning device 22 is provided. It is preferable that soap is located in the central tank 52 and the external tanks 52 contain the bleach and the water. Due to the configuration of the proportioning device 22, the suction provided by pump 12, provides a force on liquids passing through proportioning device 22. This force (negative pressure) in combination with the valves has an effect on the rate at which the liquids pass through device 22. The force provided to the passage-ways 50 on the outer ends of the proportioning device 22 is equal, whereas the force upon the central passage-way is slightly greater based on the proximate location of the hose 24 to the exit of central passage-way 50. Thus, it is preferable that soap is located in central tank 52 and fed to central passage-way 50, such that bleach and water can be accurately proportioned on the outer passage-ways 50 of proportioning device 22.

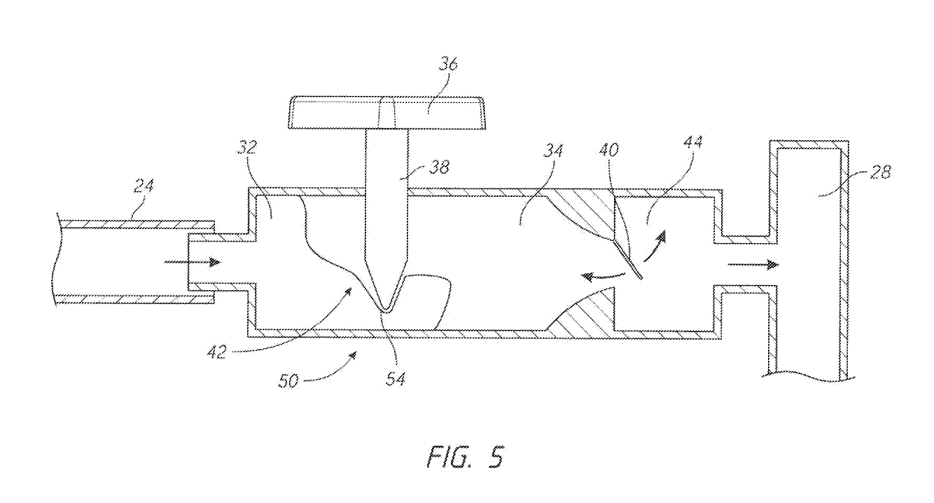

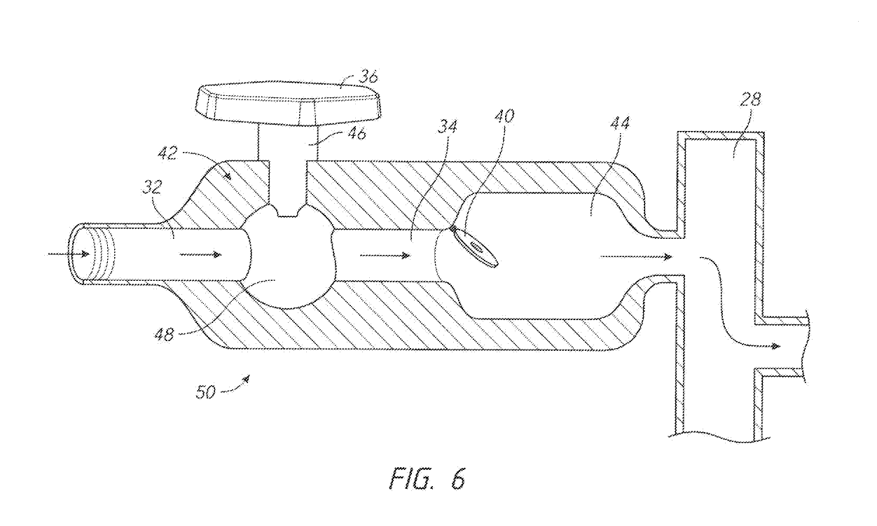

Each tank 26 is connected to a series of multi-chambered passageways 50. Multi-chambered passageways 50 include at least two valves and three chambers. Each passage-way may be comprised of separate component pieces that are threaded together or one integral device. The valves (in an open position, shown in FIGS. 5 and 6) and chambers provide a set ratio of liquid to the manifold 28, where the liquids mix to form the cleaning solution. Manifold can be any chamber or area where liquids are capable of mixing together. The cleaning solution enters a hose 24 (second hose) leading to pump 12. Pump 12 can be any type of known pump 12. For example, a positive displacement piston pump can be used to feed nozzle 20 while also providing suction to pull liquids through hose 24 from manifold 28 of proportioning device 22. The prior art nozzle 20 is attached to hose 24 (third hose) and expels cleaning solution from nozzle 20. The liquid jet 16 of cleaning solution is used to clean surfaces and objects. The reader will appreciate that the user is able to clean a surface without stopping to re-mix a cleaning solution and the ratio of liquids provided is accurate. The present method allows the user to clean concurrently with mixing the cleaning solution. While the term “hose” is used throughout this description, “hose” could be any tube or line that allows liquid to pass through it.

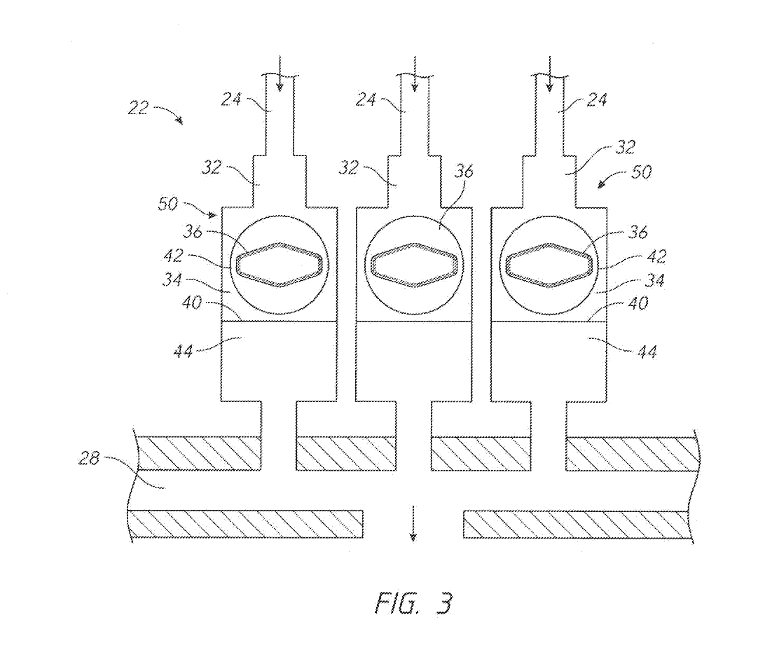

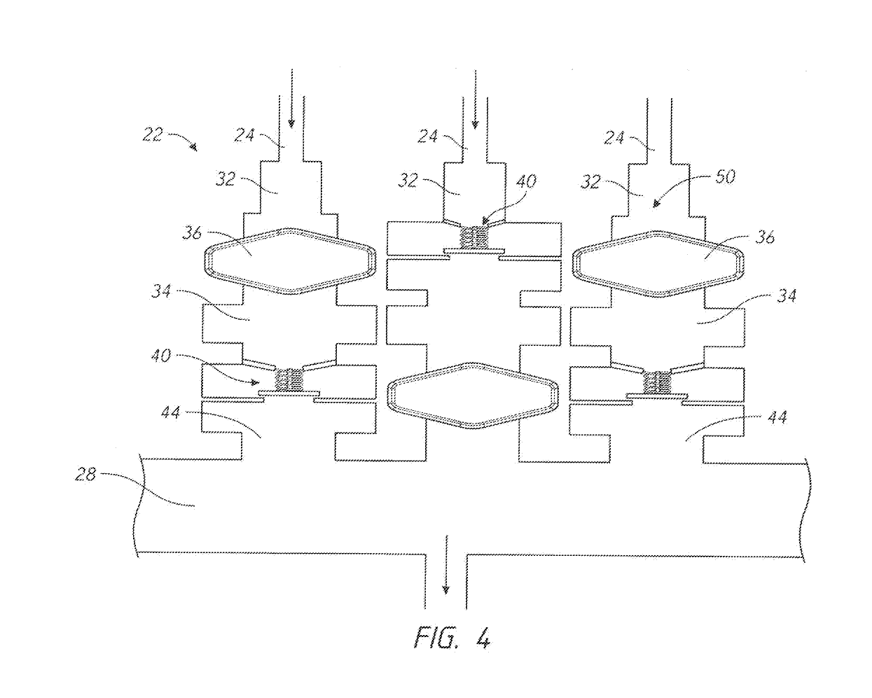

FIG. 3 is a schematic view, illustrating proportioning device 22 of the present method. Proportioning device 22 consists of at least two passageways 50. Passageways 50 are connected to a series of hoses 24, which provide a series of liquids to passageways 50. However, it is important to note that liquids could be provided by any known means. For example, liquids could be fed directly from liquid storage tanks 52 to passageways 50. Passageways 50 include a first chamber 32 (prior to a first valve), second chamber 34 (between first valve and second valve) and third chamber 44 (after second valve). Third chamber 44 is fluidly connected to manifold 28. Knob 36 is provided to set the ratio at which liquid passing through passageway 50 should be provided. Knob 36 is calibrated to give the user accurate information about the flow of liquid passing through the first valve. The liquids are mixed into cleaning solution as they enter manifold 28. The ratio of the pertinent liquids is controlled by the valves, further described below. Cleaning solution is pulled from manifold 28 into pump 12 (as shown in FIG. 1). Another embodiment of the passageways 50 is shown in FIG. 4. Knob 36 is a handle and is staggered along passageways 50 such that the user can easily select the proper ratio of liquids without contacting another knob 36. In the central passageway 50 in the present embodiment second valve 40 is located prior to first valve (not shown, but located beneath knob 36). The reader will appreciate that although the valves are labeled “first” and “second,” the label does not dictate the order in which the valves appear in the device. Thus, as is true for the central passageway 50 in the present embodiment, the second valve could be located prior to the first valve in any particular passageway (or vice versa).

A cross-section and cut-away view of passageway 50 are provided in FIGS. 5 and 6. First valve 42 is preferably a valve designed to allow the user to select the ratio of liquid to mix into the cleaning solution, such as a control valve. Second valve 40 is preferably a valve which prevents the cleaning solution from re-entering the second chamber 34. As shown in FIG. 5, liquid enters first chamber 32 from hose 24. First valve 42 includes a plunger 38, knob 36 and a beveled opening 54. Knob 36 is calibrated and marked such that the user can easily determine what ratio of liquid is passing through beveled opening 54 in comparison to the flow of liquids in the other passageways within proportioning device. Once the user sets the flow level, liquid passes from first chamber 32, through first valve 42 to second chamber 34. Liquid continues to flow through second valve 40 to third chamber 44. In the event that the pump is turned off and pressure decreases second valve 40 will close, thereby preventing liquid or cleaning solution from entering back into second chamber 34. Third chamber 44 is fluidly connected to manifold 28, wherein all liquids mix to form the desired cleaning solution. FIG. 6 is a cut-away view of passageway 50, illustrating another embodiment. It is important to note that any known valve that can perform the function of allowing a user to select the amount or flow rate of liquid to pass through it can be utilized. In this embodiment, first valve 42 is a ball valve provided to control the flow of liquid. As user turns knob 36, sphere 48 turns slowly allowing the liquid to flow through the open core of the ball or sphere 48. Liquid flows from first chamber 32 to second chamber 34 when first valve 42 is open. Second valve 40 is a swing check valve including a disc hinged at an arm. Disc can be biased downward by adding a spring or weight proximate arm, Again, in a closed position, second valve 40 prevents the backflow of liquid from third chamber 44 to second chamber 34. Liquid enters manifold 28, where cleaning solution is formed.

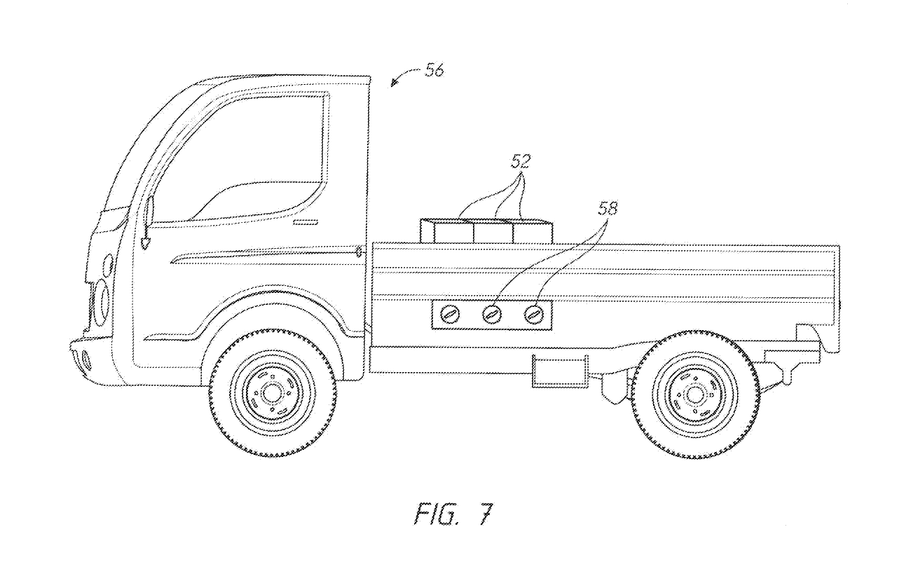

A perspective view of one storage means for the tanks 52 of the present method is illustrated in FIG. 7. As shown, tanks 52 can be permanently affixed or removably attached to a truck 56 (or vehicle). Liquid can be filled into tanks 52 when needed. Truck 56 can include access points 58 to hook up to tanks 52. The user can attach hoses to access points to allow a large range of motion for using soft washer. Although not illustrated, it should be understood that proportioning device 22 and pump 12 could be located on the truck 56, allowing the user to set the desired ratios at access point 58. After setting the ratio of desired liquids the user would be able to use lengthy hoses to attach access point 58 to hydro-cleaner 10. The user would then be able to maneuver around an area using cleaning solution.

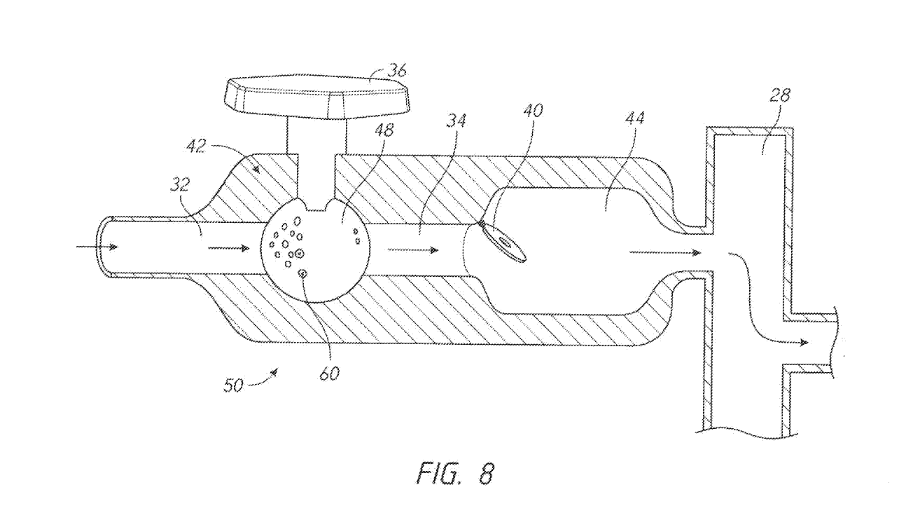

FIG. 8 shows another embodiment of the present invention. In this embodiment, first valve 42 is a specific type of ball valve. A typical ball valve, similar to the ball valve 42 shown in FIG. 6 includes a single, circular bore through sphere 48. As illustrated, sphere 48 in this embodiment includes multiple valve openings 60. As knob 36 is rotated clockwise, sphere 48 rotates and valve openings 60 are exposed. Those familiar with the art will realize that as more and more valve openings 60 are exposed to the flow, the flow will increase. This valve 42 can more accurately regulate flow do to the specific diameter and number of valve openings 60. Each exposed opening 60 increases the flow by a prescribed amount.

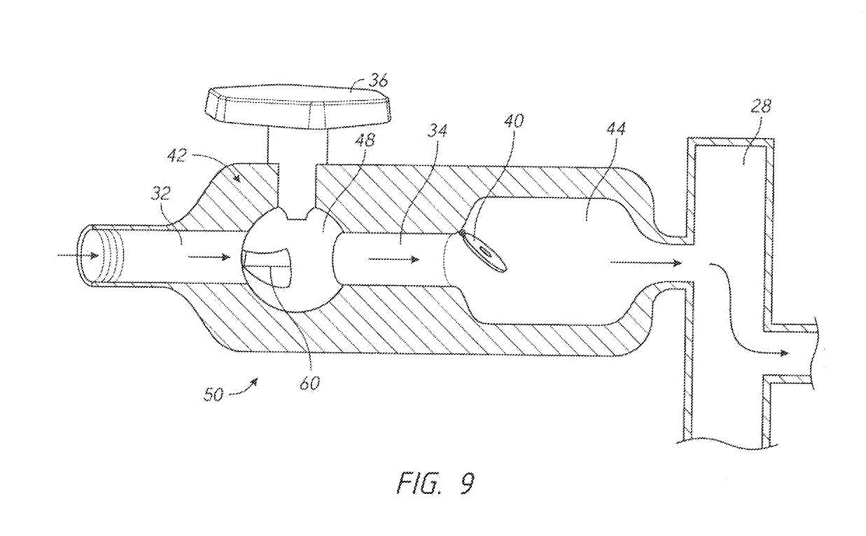

Similarly, FIG. 9 shows another embodiment of a ball valve. First valve 42 is a ball valve as in FIGS. 6 and 8. Preferably, sphere 48 includes valve opening 60. In this embodiment, valve opening 60 is has a trapezoidal profile. As with FIG. 8, this profile allows the flow rate to increase at a rate greater than if the profile was simply rectangular. As knob 36 is rotated clockwise, sphere 48 rotates and valve openings 60 are exposed. Those familiar with the art will realize that that valve opening 60 in both FIGS. 8 and 9 allow the user to more accurately control the amount of flow flowing through first valve 42.

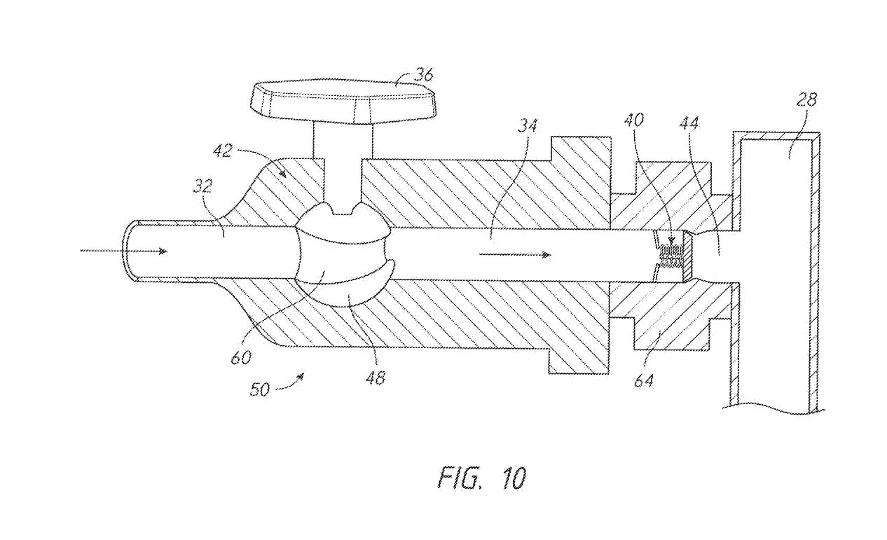

Similar to FIGS. 8 and 9, FIG. 10 shows another embodiment of a ball valve. First valve 42 is a ball valve as in FIGS. 6 and 8. Preferably, sphere 48 includes valve opening 60. In this embodiment, valve opening 60 is a v-shaped groove along the outside of sphere 48. As illustrated, v-shaped opening 60 spans 180 degrees of sphere 48 as opposed to a typical ball valve which uses 90 degrees to open and close the valve. Those familiar with the art will note that by increasing the opening span, the increments of opening valve 42 are more precise. As sphere 48 is rotated by knob 36, opening 60 is exposed. Due to the v-shaped groove of opening 60, the water flow increases as valve 52 is opened. In the preferred embodiment, second valve 40 is a check valve. FIG. 10 illustrates second valve 40 having a closing member (the movable part that blocks the flow) is a disc which is spring-loaded to assist with keeping the valve shut. A series of arms extend away from outer of component 64 to support spring. When pump 12 (shown in FIG. 2) is activated, suction causes flow in the direction of arrows as the valve disc moves away from valve seat. Although suction causes flow to begin through second valve 40, first valve 42 can regulate the amount of liquid flow to manifold 28 thereby controlling the cleaning solution that is ultimately discharged.

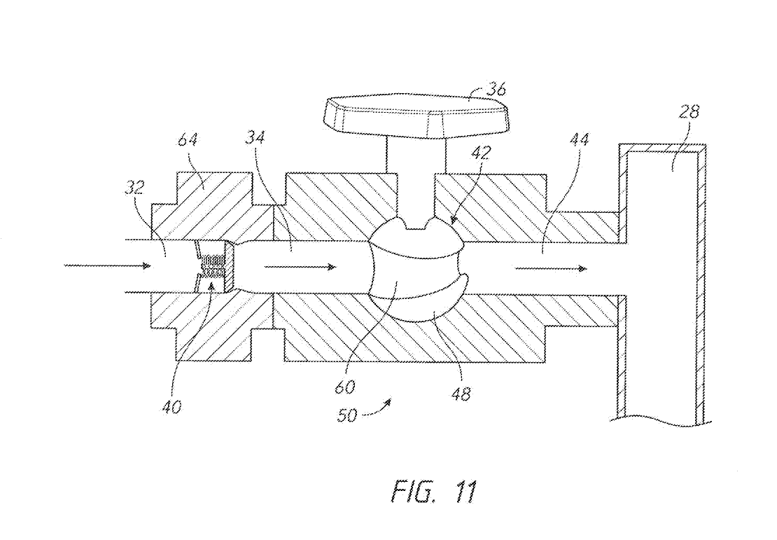

Those familiar with the art will realize that it may be beneficial to have multiple check valves within passage-way 50. The reader will note that passage-way 50 can contain harsh chemicals such as bleach. In this case, it may be preferable to include a third valve as a second check valve. It is also possible to have second valve prior to first valve, as shown in FIG. 11, Second valve 40 is a check valve, as illustrated in FIG. 10 and described above. Second valve 40 is located prior to first valve 42 in passage-way 50. In cases where passage-way 50 contains water, soap or another chemical which is not as harsh it may be preferable to include second valve 40 prior to first valve 42 in the center passage-way 50 on proportioning device 22 (shown in FIG. 2). This configuration allows the proportioning system to become more compact. This is shown in FIG. 4 where the central passage-way 50 includes knob 36 not aligned horizontally with the other knobs 36. By placing the check valve 40 upstream of ball valve 42, passage-ways 50 can be closer together. However, this arrangement causes the liquid running through passage-way 50 to remain within passage-way 50 downstream of first valve 42. In the case of harsh chemicals such as bleach this is problematic. However, this passage-way 50 can be used for soap or another mild chemical.

In general, soft washing allows the user to create mixtures with higher concentrations of soap, bleach, or other chemicals when compared with pressure or power washing. As those familiar with the art will know, the high pressure required in power washing does not allow for mixtures with less than 80 percent water. Proportioning device 22 coupled with a soft washing system allows the user to accurately mix the solution on the fly. This maximizes the cleaning power while minimizing cost (by not using or discarding more chemicals than necessary). In addition, as prior art methods rely on mixing the mixture prior to arriving on site or before the work is started, those methods cannot spray different surfaces. Typically, each surface requires a different concentration of solution. Thus, proportioning device 10 allows the user to spray one surface, adjust proportioning device 22, and then spray a different surface with a different concentrated solution without needing to manually remix a solution. In fact, this is done instantaneous and can also be done automatically,

The proportioning device 10 preferably uses chemicals in order to hydro-clean surfaces. Some of the chemicals, such as bleach (chlorine-based), are highly basic which is caustic to certain materials. Therefore, the present invention uses materials that are resistant to caustic liquids. Some examples of materials used in for proportioning device 10 which are resistive to chemicals are polyvinyl chloride (“PVC”) and polypropylene. These are commonly understood materials used for such applications due to low cost and chemical resistance.

The preceding description contains significant detail regarding the novel aspects of the present invention. It should not be construed, however, as limiting the scope of the invention but rather as providing illustrations of the preferred embodiments of the invention. Thus, the scope of the invention should be fixed by claims to be drafted, rather than by the examples given.

Having described my invention, I claim:

1. A method of combining at least two liquids for soft washing a surface with a solution mixed from at least two liquids, comprising the steps of:
providing a series of tanks separately containing said at least two liquids;
providing at least two hoses connected to each of said series of tanks;
providing a proportioning device having:
at least two passage-ways connected to said at least two hoses, wherein said at
least two passage-ways each have at least two valves; and
a manifold;
providing a pump, such that said pump creates a negative pressure within said proportioning device;
wherein said at least two liquids pass separately through said at least two hoses and enter said proportioning device;
wherein said at least two valves are capable of allowing an amount of said at least two liquids to flow through said proportioning device to said manifold when said pump is activated and at least two valves in an open position;
wherein said amount of said at least two liquids mix together to create said solution in said manifold; and
wherein said solution flows from said manifold through at least one hose to a nozzle.

2. The method as recited in claim 1, further comprising the step of spraying said solution out of said nozzle in order to clean said surface.

3. The method as recited in claim 1, wherein said at least two valves in each of said at least two passage-ways comprise a first valve and a second valve.

4. The method as recited in claim 3, wherein said first valve is a control valve.

5. The method as recited in claim 3, wherein said second valve is a check valve.

6. The method as recited in claim 3, wherein said proportioning device further comprises a knob attached to said first valve of each of said at least two passage-ways such that said knob is capable of being adjusted to regulate said amount of said at least two liquids flowing through said at least two passage-ways.

7. The method as recited in claim 1, wherein said series of tanks has a top and a base, wherein said at least two hoses connected to said series of tanks enter said top of said tank and extend downward within said at least two liquids to said base of said tank.

8. The method as recited in claim 3, wherein said first valve and said second valve are contained within separate component pieces that attach together to form said proportioning device.

9. A method of combining at least two liquids for soft washing a surface with a solution mixed from three liquids, comprising the steps of:
providing three tanks capable of containing said three liquids;
providing at least three first hoses connected to each of said three tanks;
providing a proportioning device connected to said at least three first hoses, comprising;
three passage-ways each connected to said at least three first hoses;
a manifold fluidly connected to said three passage-ways; and
wherein each of said three passage-ways have a first valve and a second valve which separate said three passage-ways into a first chamber before said first valve, a second chamber between said first valve and said second valve and a third chamber after said second valve;
providing a second hose connected to said manifold;
providing a pump connected to said second hose, such that said pump is capable of causing a negative pressure within said manifold of said proportioning device;
providing a third hose connected to said pump and a nozzle; and
calibrating said first valve of each of said three passage-ways.

10. The method as recited in claim 9, further comprising the step of spraying said solution out of said nozzle in order o clean said surface.

11. The method as recited in claim 9, wherein said first valve is a control valve.

12. The method as recited in claim 9, wherein said second valve is a check valve.

13. The method as recited in claim 9, wherein said proportioning device further comprises a knob attached to said first valve of each of said three passage-ways.

14. The method as recited in claim 13, wherein said step of calibrating said first valve of said three passage-ways allows a user to select a ratio of said three liquids to mix together to form said solution by adjusting said knob on each of said three passage-ways.

15. The method as recited in claim 9, wherein said three liquids are water, soap and bleach.

16. The method as recited in claim 15, wherein said at least three passage-ways have a central passage-way between two external passage-ways.

17. The method as recited in claim 16, wherein said soap is passed through said central passage-way and said water and said bleach are passed through said two external passage-ways.

18. The method as recited in claim 9, wherein said three tanks have a top and a base, wherein said three first hoses connect to said three tanks by entering said top of said tank and extending downward within said three liquids to said base of said three tanks.

19. The method as recited in claim 18, wherein said first valve and said second valve are contained within separate component pieces that attach together to form said proportioning device.
